(19) United States
(12) Patent Application Publication
(10) Pub. No.: US 2024/0069402 A1
(43) Pub. Date: Feb. 29, 2024

(54) CONTROL AND OPERATION OF NON-LIGHT-EMITTING VARIABLE TRANSMISSION DEVICES DURING SENSOR FAILURE

(71) Applicant: Sage Electrochromics, Inc., Faribault, MN (US)

(72) Inventors: Bryan D. Greer, Northfield, MN (US); David J. Best, Elysian, MN (US); Ahoo Malekafzali Ardakan, Cottonwood Heights, UT (US)

(21) Appl. No.: 18/451,931

(22) Filed: Aug. 18, 2023

Related U.S. Application Data
(60) Provisional application No. 63/371,850, filed on Aug. 18, 2022.

(51) Int. Cl. G02F 1/163; G02F 1/1524; G02F 1/155

(52) U.S. Cl. CPC G02F 1/163; G02F 1/1524; G02F 1/155; G02F 2001/1552

(57) ABSTRACT

A system can include one or more sensors, one or more non-light emitting, variable transmission devices, and a processor coupled to the one or more non-light emitting, variable transmission devices and the one or more sensors. The processor can be configured to receive a sensor failure signal from the one or more sensors. The sensor failure signal can indicate that the one or more sensors are not working. The processor can be further configured to adjust one or more control algorithms used to control the one or more non-light emitting, variable transmission devices based on the received sensor failure signal. The processor can be further configured to send a first command to the one or more non-light emitting, variable transmission devices to change a transmission state of all of the one or more non-light emitting, variable transmission devices based on the received sensor failure signal to a sensor failure transmission state.

### CROSS-REFERENCE TO RELATED APPLICATION(S)

This application claims priority under 35 U.S.C. § 119(e) to U.S. Provisional Patent Application No. 63/371,850, filed Aug. 18, 2022, by Bryan D. GREER et al., entitled “CONTROL AND OPERATION OF NON-LIGHT-EMITTING VARIABLE TRANSMISSION DEVICES DURING SENSOR FAILURE,” which is assigned to the current assignee hereof and incorporated herein by reference in its entirety for all purposes.

### FIELD OF THE DISCLOSURE

The present disclosure is directed to systems that include non-light-emitting variable transmission devices, and more specifically to controls for non-light-emitting variable transmission devices and methods of using the same.

### BACKGROUND

A non-light-emitting variable transmission device can reduce glare and the amount of sunlight entering a room or passenger compartment. Non-light-emitting variable transmission devices, such as electrochromic (EC) devices, employ materials capable of reversibly altering their optical properties following electrochemical oxidation and reduction in response to an applied potential. The optical modulation is the result of the simultaneous insertion and extraction of electrons and charge compensating ions in the electrochemical material lattice. Conventionally, an electrochromic device can be at a particular transmission state. For example, the electrochromic device may be set to a certain tint level (i.e., a percentage of light transmission through the electrochromic device), such as full tint (e.g., about 0.5% transmission level), full clear (e.g., 63%+/−10% transmission level).

There are several means by which an electrochromic device can switch between tint and clear states. For example, there can be manual control or control based on a series of algorithms. Those algorithms can take into account various factors that are measured or inputted, such as for example, variations in the voltages, the resistance within the device, the time of day or position of the sun, or the temperature at any given time. Knowing and understanding the parameters for control of the devices can help optimize performance of the device. However, should those parameters for control fail, the system performance too can fail. As such, a need exists for a better control strategy for an electrochromic device.

### BRIEF DESCRIPTION OF THE DRAWINGS

Embodiments are illustrated by way of example and are not limited in the accompanying figures.

FIG. 1 includes a schematic depiction of a system for controlling a set of non-light-emitting, variable transmission devices in accordance with an embodiment.

FIG. 2 includes a flow diagram for operating the system of FIG. 1.

FIG. 3 includes an of a cross-sectional view of the non-light emitting, variable transmission device, according to one embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

The terms “normal operation” and “normal operating state” refer to conditions under which an electrical component or device is designed to operate. The conditions may be obtained from a data sheet or other information regarding voltages, currents, capacitances, resistances, or other electrical parameters. Thus, normal operation does not include operating an electrical component or device well beyond its design limits.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present), and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the control system and electrochromic arts.

A system can include one or more non-light-emitting, variable transmission devices; and a processor coupled and configured to provide control signals to the non-light-emitting, variable transmission devices.

The systems and methods are better understood after reading the specification in conjunction with the figures. System architectures are described and illustrated, followed by an exemplary construction of a non-light-emitting, variable transmission device, and a method of controlling the system. The embodiments described are illustrative and not meant to limit the scope of the present invention, as defined by the appended claims.

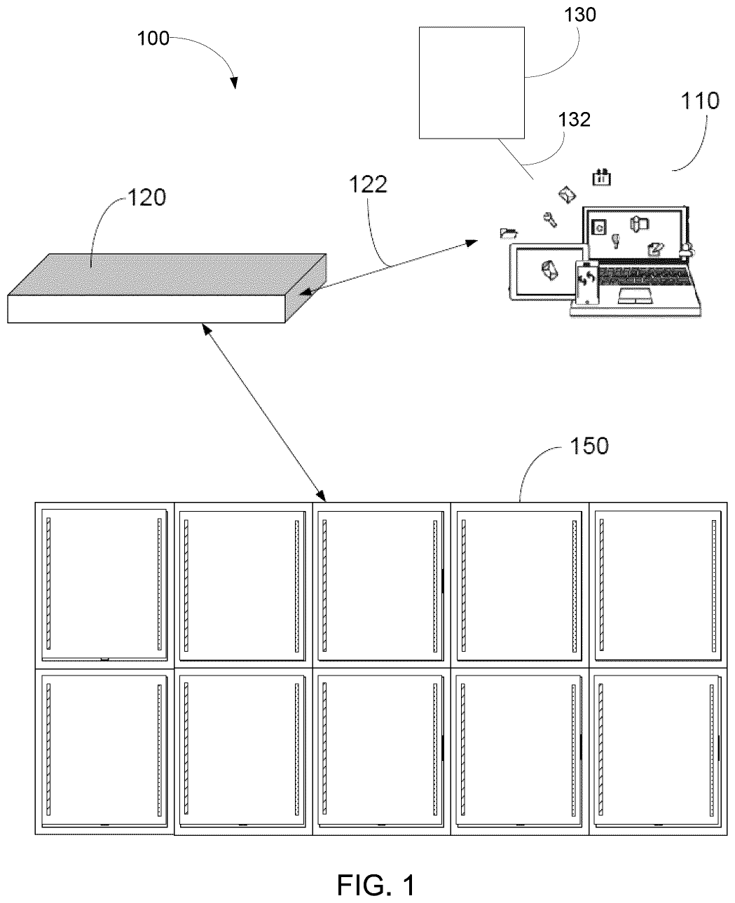

Referring to FIG. 1, a system for controlling a set of non-light-emitting, variable transmission devices is illustrated and is generally designated 100. The system 100 can include logic to control the operation of the heating ventilation air condition (HVAC) system of the building, interior lighting, exterior lighting, emergency lighting, fire suppression equipment, elevators, escalators, alarms, security cameras, access doors, another suitable component or sub-system of the building, or any combination thereof. The logic for the control management system can be in the form of hardware, software, or firmware. In a particular embodiment, the logic can be within a computing device such as a desktop computer, a laptop computer, a tablet computer, a smartphone, some other computing device, or a combination thereof. The logic may be in a separate location from the non-light-emitting, variable transmission devices. In an embodiment, the logic may be stored in a field programmable gate array (FPGA), an application-specific integrated circuit (ASIC), a hard drive, a solid state drive, or another persistent memory. In an embodiment, the control management system may include a processor 110 that can execute instructions stored in memory within the control management system or received from an external source.

The system 100 can be used to regulate the transmission of an insulated glazing unit (IGU) installed as part of architectural glass along a wall of a building or a skylight, or within a vehicle as well as to evaluate the performance of the one or more IGU's. As depicted, the system 100 can include a processor 110, a controller 120, one or more sensors 130, and a frame panel 150.

As illustrated in FIG. 1, the controller 120 can be connected to the processor system 110 via a control link 122. The control link 122 can be a wired connection, such as in a local area network or Ethernet network. The control link 122 can be a wireless connection. In an embodiment, the control link 122 can use a wireless local area network connection operating according to one or more of the standards within the IEEE 802.11 (WiFi) family of standards. In a particular aspect, the wireless connections can operate within the 2.4 GHz ISM radio band, within the 5.0 GHz ISM radio band, or a combination thereof. Regardless of the type of control link 122, the processor 110 can provide control signals to the controller 120 via the control link 122. The control signals can be used to control the operation of one or more non-light-emitting variable transmission devices that are indirectly, or directly, connected to the controller 120. In another embodiment, signals from the controller 120 can go to the processor 110 via the control link 122.

In an embodiment, the building management system 110 may include a processor that can execute instructions stored in memory within the building management system 110 or received from an external source. In one embodiment, the external sensors can include a rooftop device. In one embodiment, and as discussed in further detail below, the signals can include data from one or more sensors 130 used to provide information for controlling the one or more non-light emitting, variable transmission devices within the window frame 150. The one or more sensors 130 can be connected to the building management system 110 or more specifically the processor via a control link 132. The control link 132 can be similar to the control link 122. In one embodiment, the one or more sensors 130 can be located at the same location as the one or more non-light emitting variable transmission devices; for instance, within the window frame or within the same room. In another embodiment, the one or more sensors 130 can be located at a separate location from the one or more non-light emitting, variable transmission devices; for instance, on the roof or outside of the building that contains the window frame 150. The sensor 130 can be mounted on the roof of a building that contains the non-light emitting, variable transmission devices. In one embodiment, the external sensors can include 360-degree sensors. In another embodiment, the external sensors can include 180-degree sensors. Each sensor can return measurements on LUX, temperature, irradiance, direction, levels of light, weather measurements, and orientation, and more. In one embodiment, the sensor can be powered by either 24 V or power over Ethernet (POE). By combining the data from the plurality of sensors, the processor can receive data from a 360-degree field of view. In one embodiment, data from a single sensor can be taken. As such, the processor can receive data from between a 5-degree and 360-degree field of view based from a central point of the device. Each sensor can be provided information related to light intensity, temperature, sun position, time of day, level of cloudiness, or another suitable parameter, or any combination thereof.

As seen in FIG. 1, the window frame panel 150 can include a plurality of non-light-emitting, variable transmission devices. In the embodiment as illustrated, the controller may be electrically connected to one or more non-light-emitting, variable transmission devices. In another embodiment, a different number of non-light-emitting, variable transmission devices, a different matrix of the non-light-emitting, variable transmission devices, or both may be used. In yet another embodiment, one or more controllers may be connected to both the controller and the one or more non-light-emitting, variable transmission devices. The controllers 120 can be used to control operation of the non-light-emitting, variable transmission devices. Each of the non-light-emitting, variable transmission devices may be on separate glazings. In another embodiment, a plurality of non-light-emitting, variable transmission devices can share a glazing. In another embodiment, a pair of glazings in the window frame panel 150 can have different sizes, such glazings can have a different number of non-light-emitting, variable transmission devices. After reading this specification, skilled artisans will be able to determine a particular number and organization of non-light-emitting, variable transmission devices for a particular application.

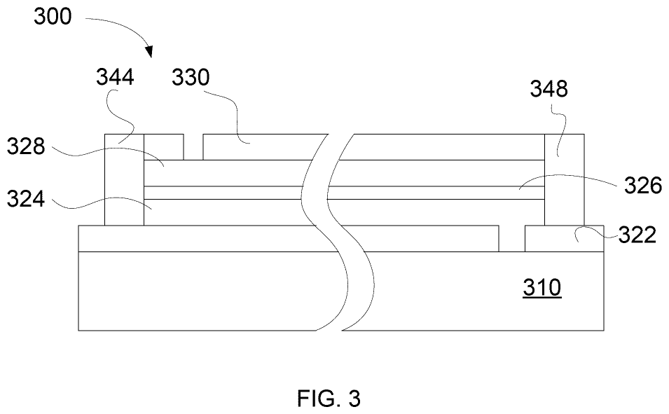

The system can be used with a wide variety of different types of non-light-emitting variable transmission devices, as described in more detail with respect to FIG. 3. The apparatuses and methods can be implemented with switchable devices that affect the transmission of light through a window. Much of the description below addresses embodiments in which the switchable devices are electrochromic devices. In other embodiments, the switchable devices can include suspended particle devices, liquid crystal devices that can include dichroic dye technology, and the like. Thus, the concepts as described herein can be extended to a variety of switchable devices used with windows.

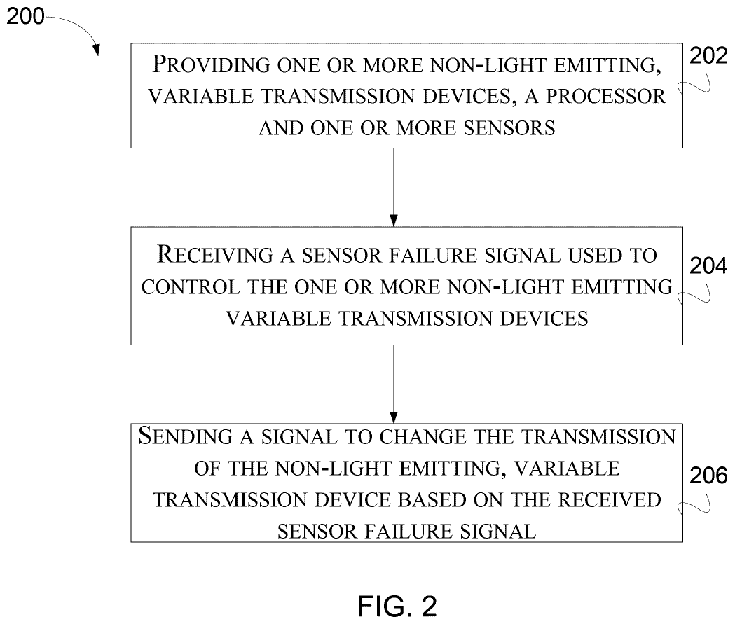

FIG. 2 includes a flow diagram for a method 200 of operating the system 100 illustrated in FIG. 1. In one embodiment, the processor 110 can include a memory that is configured to implement a device monitoring and control system for the system 100 to perform the method steps described below. In particular, the processor 110 can include a logic element, which can be configured to continuously monitor the health of the system and in particular the functionality of a sensor. In one embodiment, the logic element can determine if a sensor has failed, and in the event of a failed sensor, adjust the control of the non-light-emitting, variable transmission devices.

Commencing at block 202, the method can include providing one or more non-light-emitting, variable transmission devices, one or more sensors, and a processor coupled to the one or more non-light-emitting, variable transmission devices and the one or more sensors. In an embodiment, the non-light-emitting, variable transmission devices, sensors, and processor may be connected to each other as illustrated in FIG. 1. In an embodiment, the non-light-emitting variable transmission devices may be similar to the non-light-emitting variable transmission device described and illustrated in FIG. 3. During normal operation, the sensors can send data to the processor that can be used in various algorithms to determine and control the transmission state of the one or more non-light emitting, variable transmission devices. In one embodiment, during normal operations, the sensors can send information related to measurements on LUX, temperature, irradiance, and weather. Such information received from the sensors can then be used within various different algorithms to cause the processor to send control signals to the one or more non-light emitting, variable transmission devices to change the transmission state of the one or more non-light emitting, variable transmission devise. In another embodiment, information received from the sensors can cause the processor to send control signals to the one or more non-light emitting, variable transmission devices to change from a tinted transmission state to a clear transmission state. In another embodiment, information received from the sensors can cause the processor to send control signals to the one or more non-light emitting, variable transmission devices to change from a clear transmission state to a tinted transmission state.

The system 100 can be used to control the one or more non-light emitting, variable transmission devices within a window, such as an IGU installed as part of architectural glass along a wall of a building or a skylight, or within a vehicle. Doing so often requires weighing a number of factors, processing the information received, prioritizing the information received, and sending instructions to control the electrochromic devices based on that prioritized information. As described above, sensors can provide information to the processor to control the transmission state of the one or more non-light emitting, variable transmission devices. However, sensors are not the only source of information received. In one embodiment, the factors can include information received from the sensors, from a control model, inputted data, or other data from external sources.

As the number of devices for a controlled space increases, the complexity in processing and prioritizing the information so too increases. Moreover, with such a complex system, determining if a failure within the system has occurred or where a failure in the system has occurred can be difficult and time consuming. Even further complexity can occur when the control of the EC devices is integrated with other building environmental controls. Additionally, if data received is integrated into multiple control algorithms and a failure within the system has occurred, it could affect the entire operation of the electrochromic devices.

In one such case, for example, if one of the sensors fails, the processor will not receive that data from the sensors to change to the transmission level of the one or more non-light emitting, variable transmission devices based on the information received from a normal and functioning sensor. Sensors can provide information that is utilized in several control algorithms. Since the data is not being received, in order to ensure a smooth user experience when a failure occurs, the system can have one or more default procedures to adjust for the failure. In one embodiment, when one or more sensors fail, a default algorithm is activated within the processor for controlling the one or more non-light emitting, variable transmission devices that compensates for the data not being received from the one or more sensor failures.

Continuing the description of the method 200, at block 204, the method can include receiving a sensor failure signal from one or more of the sensors used to control the non-light emitting, variable transmission devices of the glazing. In one embodiment, the one or more failed sensors can no longer send information to the processor. In one embodiment, the processor receives no data from the one or more sensors, indicating a sensor failure. In one embodiment, a failed sensor signal is sent to the processor after the processor receives a reading of less than 10 Lux within a 12-hour period from the one or more sensors. In one embodiment, a failed sensor signal is sent to the processor after the processor receives a reading of less than 15 Lux within a period of between 8 to 12 hours from the one or more sensors. In another embodiment, a failed sensor signal is sent to the processor after the processor receives a reading of less than 15 Lux during the daytime. In one embodiment, a failed sensor signal is sent to the processor after the processor receives a reading of less than 20 Lux in a 24-hour period from the one or more sensors.

Once the processor receives a sensor failure signal, the processor can activate a default procedure for controlling the one or more non-light emitting, variable transmission devices. The default procedure can control the one or more non-light emitting, variable transmission devices without the data received from the failed sensor. In one embodiment, the default procedure can be a default algorithm. In one embodiment, the default procedure can include adjusting the algorithms that use the information from the one or more sensors by omitting the factors normally received from the sensor and moving to the next highest prioritized algorithm in the prioritization scheme for control the one or more non-light emitting, variable transmission devices.

In one embodiment, the processor receives a sensor failure signal. In one embodiment, the processor sends a request for data to the sensor but does not receive a response from the sensor. In another embodiment, the processor does not receive any data from the sensor for a period of time between 5 minutes and 48 hours. In one embodiment, the processor does not receive any data from the sensor for a period of time between 1 hour and 24 hours. The memory can be configured to keep a running log of data types received from the one or more non-light-emitting, variable transmission devices. In one embodiment, the processor 110 can receive data of system failure from the one or more non-light emitting, variable transmission devices. The processor 110 can then evaluate the data of system failure and execute a failure command. In one embodiment, the failure command can change the prioritization of the data received to control the one or more non-light emitting, variable transmission devices.

After the processor receives a failed sensor signal, or fails to receive data from the sensor, the processor unit, at block 206, can re-analyze the factors received to, omitting the data normally received from the one or more sensors, to adjust for the failed sensor, move to the next highest prioritized algorithm, and control the transmission state for the one or more non-light emitting, variable transmission devices based on a new set of factors. During normal operations, the one or more sensors can send real-time measured data as to factors, such as weather, to aid in controlling the transmission state of the non-light emitting, variable transmission devices. The default procedure can include an algorithm that can take into account information that is a prediction of what may be expected though is not directly measured. In one embodiment, the default procedure can include an algorithm that can take into account the time of day, the date, the position of the sun in the sky, saved scenes, data based from a model, and other data in prioritizing the default. During normal operation, the processor can gather all of the data from the various sources and prioritize them. In one embodiment, the processor can gather all of the data from the various sources and combine them in order to control the non-light emitting, variable transmission devices. The default procedure can utilize the prioritization scheme that was created during normal operations, omit any factor that would utilize data received from a sensor, adjust the algorithms that utilize data from the sensors, and control the one or more non-light emitting, variable transmission devices based on the next highest prioritized factor after the sensor data has been omitted. In one embodiment, adjusting the algorithms that utilize data from the sensors, can include running the algorithm without sensor data. For instance, if an algorithm depends on two factors to run, and one of those factors is data from a sensor, then the algorithm can be adjusted to run based on solely one factor, omitting the data from the sensor. In one embodiment, the processor sends a signal to change the transmission state of the one or more non-light emitting, variable transmission devices from their current state to a new state based on the default algorithm.

In one embodiment, the one or more non-light emitting, variable transmission devices can be controlled by the default procedure for between 30 minutes to 48 hours. In another embodiment, the one or more non-light emitting, variable transmission devices can be controlled by the default procedure until the sensor is fixed. In another embodiment, the one or more non-light emitting, variable transmission devices can be controlled by the default procedure until the processor receives data from the one or more sensors. Utilizing a default algorithm and procedure in controlling the one or more non-light emitting, variable transmission devices has benefits: first, by adjusting the algorithms that would during normal operation utilize data received from a sensor, the algorithms can still be utilized instead of turned off completely because of incomplete data; second, a user may not notice that there is a problem with the system and may not experience disruption in service; third, utilizing a default procedure helps maintain a cool environment within a space without losing the visibility of the window even when a problem in the system has occurred. As such, by initiating a default procedure, the processor can still maintain the environment within the space at a temperature between 65 degrees Fahrenheit and 75 degrees Fahrenheit, such as room temperature. In another embodiment, the default state maintains the environment within a space at a temperature between 70 degrees Fahrenheit and 75 degrees Fahrenheit.

The method 200 can further include continuously evaluating the health of the one or more sensors. In one embodiment, a failed sensor may be fixed. In another embodiment, a sensor that was not sending data can begin to send data again to the processor. In another embodiment, the processor that was not receiving data from the sensor begins receiving data from the sensor. In the default procedure, the processor controlled the transmission state of the one or more non-light emitting, variable transmission devices based on an adjusted algorithm. Once data from the one or more sensors is received, the processor can once again include the measured data received from the one or more sensors to more accurately control the transmission state of the one or more non-light emitting, variable transmission devices.

The description with respect to FIG. 3 provides exemplary embodiments of a glazing that includes a glass substrate and a non-light-emitting variable transmission device disposed thereon. The embodiment as described with respect to FIG. 3 is not meant to limit the scope of the concepts as described herein. For purposes of illustrative clarity, the non-light-emitting variable transmission device 300 can be an electrochromic device. In the description below, a non-light-emitting variable transmission device will be described as operating with voltages on bus bars being in a range of 0 V to 3 V. Such description is used to simplify concepts as described herein. Other voltage may be used with the non-light-emitting variable transmission device or if the composition or thicknesses of layers within an electrochromic stack are changed. The voltages on bus bars with respect to ground may both be positive (1 V to 4 V), both negative (−5 V to −2 V), or a combination of negative and positive voltages (−1 V to 2 V), as it is the voltage between bus bars which is important. Furthermore, the voltage difference between the bus bars may be less than or greater than 3 V. After reading this specification, skilled artisans will be able to determine voltage differences for different operating modes to meet the needs or desires for a particular application. The embodiments are exemplary and not intended to limit the scope of the appended claims.

In accordance with the present disclosure, FIG. 3 illustrates a cross-section view of a partially fabricated electroactive device 300 having an improved film structure. For purposes of illustrative clarity, the electroactive device 300 can be a variable transmission electrochromic device. In another embodiment, the electroactive device 300 can be a thin-film battery. In yet another embodiment, the electroactive device 300 can be a liquid crystal device. In another embodiment, the electroactive device 300 can be an organic light emitting diode device or light emitting diode device. In another embodiment, the electroactive device 300 can be a dichroic device. However, it will be recognized that the present disclosure is similarly applicable to other types of scribed electroactive devices, electrochemical devices, as well as other electrochromic devices with different stacks or film structures (e.g., additional layers). The electroactive devices can be laminates or can be part of an insulated glazing unit, as described below.

With regard to the electroactive device 300 of FIG. 3, the device 300 may include a substrate 310 and a stack overlying the substrate 310. The stack may include a first transparent conductor layer 322, a cathodic electrochemical layer 324, an anodic electrochemical layer 328, and a second transparent conductor layer 330. In one embodiment, the cathodic electrochemical layer can also be referred to as an electrochromic layer. In one embodiment, the anodic electrochemical layer can also be referred to as counter electrode layer. In one embodiment, the stack may also include an ion conducting layer 326 between the cathodic electrochemical layer 324 and the anodic electrochemical layer 328.

In an embodiment, the substrate 310 can include a glass substrate, a sapphire substrate, an aluminum oxynitride substrate, or a spinel substrate. In another embodiment, the substrate 310 can include a transparent polymer, such as a polyacrylic compound, a polyalkene, a polycarbonate, a polyester, a polyether, a polyethylene, a polyimide, a polysulfone, a polysulfide, a polyurethane, a polystyrene, a polyvinylacetate, another suitable transparent polymer, or a co-polymer of the foregoing. The substrate 310 may or may not be flexible. In a particular embodiment, the substrate 310 can be float glass or a borosilicate glass and have a thickness in a range of 0.5 mm to 12 mm thick. The substrate 310 may have a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm. In another particular embodiment, the substrate 310 can include ultra-thin glass that is a mineral glass having a thickness in a range of 50 microns to 300 microns. In a particular embodiment, the substrate 310 may be used for many different electrochemical devices being formed and may referred to as a motherboard.

Transparent conductive layers 322 and 330 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 322 and 330 can include gold, silver, copper, nickel, aluminum, or any combination thereof. The transparent conductive layers 322 and 330 can include indium oxide, indium tin oxide, doped indium oxide, tin oxide, doped tin oxide, zinc oxide, doped zinc oxide, ruthenium oxide, doped ruthenium oxide and any combination thereof. The transparent conductive layers 322 and 330 can have a thickness between 10 nm and 600 nm. In one embodiment, the transparent conductive layers 322 and 330 can have a thickness between 200 nm and 500 nm. In one embodiment, the transparent conductive layers 322 and 330 can have a thickness between 320 nm and 460 nm. In one embodiment the first transparent conductive layer 322 can have a thickness between 10 nm and 600 nm. In one embodiment, the second transparent conductive layer 330 can have a thickness between 80 nm and 600 nm.

The layers 324 and 328 can be electrode layers, wherein one of the layers may be a cathodic electrochemical layer, and the other of the layers may be an anodic electrochromic layer (also referred to as a counter electrode layer). In one embodiment, the cathodic electrochemical layer 324 is an electrochromic layer. The cathodic electrochemical layer 324 can include an inorganic metal oxide material, such as WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), or any combination thereof and can have a thickness in a range of 40 nm to 600 nm. In one embodiment, the cathodic electrochemical layer 324 can have a thickness between 100 nm and 400 nm. In one embodiment, the cathodic electrochemical layer 324 can have a thickness between 350 nm to 390 nm. The cathodic electrochemical layer 324 can include lithium, aluminum, zirconium, phosphorus, nitrogen, fluorine, chlorine, bromine, iodine, astatine, boron; a borate with or without lithium; a tantalum oxide with or without lithium; a lanthanide-based material with or without lithium; another lithium-based ceramic material; or any combination thereof.

The anodic electrochromic layer 328 can include any of the materials listed with respect to the cathodic electrochromic layer 324 or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 40 nm to 500 nm. In one embodiment, the anodic electrochromic layer 328 can have a thickness between 150 nm to 300 nm. In one embodiment, the anodic electrochromic layer 328 can have a thickness between 250 nm to 290 nm. In some embodiments, lithium may be inserted into at least one of the first electrode 330 or second electrode 340.

In another embodiment, the device 300 may include a plurality of layers between the substrate 310 and the first transparent conductive layer 322. In one embodiment, an antireflection layer can be between the substrate 310 and the first transparent conductive layer 322. The antireflection layer can include SiO₂, NbO₂, Nb₂O₅ and can be a thickness between 20 nm to 100 nm. The device 300 may include at least two bus bars with one bus bar 344 electrically connected to the first transparent conductive layer 322 and the second bus bar 348 electrically connected to the second transparent conductive layer 330. Any of the electrochromic devices can be subsequently processed as a part of an insulated glass unit (IGU) or laminate device. The IGU can be installed as part of architectural glass along a wall of a building or a skylight, or within a vehicle.

Embodiments as described above can provide benefits over other systems with non-light-emitting, variable transmission devices. The use of remote scene selection and control can help with maintenance of an installed device. The methods as described herein allow all non-light-emitting, variable transmission devices coupled to be controlled individually based on the state information received and prioritization of that state information.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the embodiments as listed below.

Embodiment 1. A system, comprising:
one or more sensors;
one or more non-light emitting, variable transmission devices; and
a processor coupled to the one or more non-light emitting, variable transmission devices and the one or more sensors, wherein the processor is configured to:
   receive a sensor failure signal from the one or more sensors, wherein the sensor failure signal indicates the one or more sensors are not working; and
   adjust one or more control algorithms used to control the one or more non-light emitting, variable transmission devices based on the received sensor failure signal.

Embodiment 2. The system of embodiment 1, wherein adjusting the one or more control algorithms used to control the one or more non-light emitting, variable transmission devices comprising running the algorithm on calculated data and omitting measured data from the one or more sensors.

Embodiment 3. The system of embodiment 1, wherein the processor is further configured to control the transmission state of the one or more non-light emitting, variable transmission devices with the adjusted control algorithms.

Embodiment 4. The system of embodiment 1, wherein the processor is further configured to prioritize the one or more control algorithms during normal operation before receiving a sensor failure signal from the one or more sensors.

Embodiment 5. The system of embodiment 4, wherein adjusting the one or more control algorithms used to control the one or more non-light emitting, variable transmission devices comprises utilizing the prioritization of the one or more control algorithms created during normal operations.

Embodiment 6. The system of embodiment 1, wherein the processor is further configured to receive an active sensor signal, wherein the active sensor signal indicates the one or more sensors are working.

Embodiment 7. The system of embodiment 1, wherein the processor is further configured to determine whether a time-out frame is reached.

Embodiment 8. The system of embodiment 7, wherein the time-out frame is between 24 hours and 48 hours.

Embodiment 9. The system of embodiment 1, wherein each of the one or more non-light emitting, variable transmission devices comprises:
a substrate;
a first transparent conductive layer;
a second transparent conductive layer;
a cathodic electrochemical layer between the first transparent conductive layer and the second transparent conductive layer; and
an anodic electrochemical layer between the first transparent conductive layer and the second transparent conductive layer.

Embodiment 10. The system of embodiment 9, wherein each of the one or more electrochromic devices further comprises an ion conducting layer between the cathodic electrochemical layer and the anodic electrochemical layer.

Embodiment 11. The system of embodiment 10, wherein the ion-conducting layer comprises lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, or any combination thereof.

Embodiment 12. The system of embodiment 9, wherein the cathodic electrochemical layer comprises WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 13. The system of embodiment 9, wherein the first transparent conductive layer comprises indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 14. The system of embodiment 9, wherein the second transparent conductive layer comprises indium oxide, indium tin oxide, doped indium oxide, tin oxide, doped tin oxide, zinc oxide, doped zinc oxide, ruthenium oxide, doped ruthenium oxide and any combination thereof.

Embodiment 15. A method for controlling one or more non-light emitting, variable transmission devices, comprising:
receiving a sensor failure signal from one or more sensors, wherein the sensor failure signal indicates the one or more sensors are not working, and wherein receiving the sensor failure signal is performed by a processor connected to the one or more sensors;
adjusting one or more control algorithms used to control the one or more non-light emitting, variable transmission devices based on the received sensor failure signal; and
sending a first command to the one or more non-light emitting, variable transmission devices to change a transmission state of at least one of the one or more non-light emitting, variable transmission devices based on the adjusted one or more control algorithms.

Embodiment 16. The method for controlling the one or more non-light emitting, variable transmission devices of embodiment 15, wherein adjusting the one or more control algorithms used to control the one or more non-light emitting, variable transmission devices comprising running the algorithm on calculated data and omitting measured data from the one or more sensors.

Embodiment 17. The method for controlling the one or more non-light emitting, variable transmission devices of embodiment 15, further comprising receiving data from the one or more sensors after the first command is sent.

Embodiment 18. The method for controlling the one or more non-light emitting, variable transmission devices of embodiment 17, further comprising adjusting a second time the one or more control algorithms after the data from the one or more sensors is received to run the one or more control algorithms based on both calculated data and measured data from the one or more sensors.

Embodiment 19. The method for controlling the one or more non-light emitting, variable transmission devices of embodiment 18, sending a second command to the one or more non-light emitting, variable transmission devices to change the transmission state of all of the one or more non-light emitting, variable transmission devices based on the second adjusted one or more control algorithms.

Embodiment 20. A non-transitory computer readable medium containing a program of instructions for controlling one or more non-light-emitting, variable transmission devices, execution of which by a processor causes the steps of:
receiving a sensor failure signal from one or more sensors, wherein the sensor failure signal indicates the one or more sensors are not working, and wherein receiving the sensor failure signal is performed by a processor connected to the one or more sensors;
adjusting one or more control algorithms used to control the one or more non-light emitting, variable transmission devices based on the received sensor failure signal; and
sending a first command to the one or more non-light emitting, variable transmission devices to change a transmission state of all of the one or more non-light emitting, variable transmission devices based on the received sensor failure signal.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A system, comprising:
one or more sensors;
one or more non-light emitting, variable transmission devices; and
a processor coupled to the one or more non-light emitting, variable transmission devices and the one or more sensors, wherein the processor is configured to:
receive a sensor failure signal from the one or more sensors, wherein the sensor failure signal indicates the one or more sensors are not working; and
adjust one or more control algorithms used to control the one or more non-light emitting, variable transmission devices based on the received sensor failure signal.

2. The system of claim 1, wherein adjusting the one or more control algorithms used to control the one or more non-light emitting, variable transmission devices comprising running the algorithm on calculated data and omitting measured data from the one or more sensors.

3. The system of claim 1, wherein the processor is further configured to control the transmission state of the one or more non-light emitting, variable transmission devices with the adjusted control algorithms.

4. The system of claim 1, wherein the processor is further configured to prioritize the one or more control algorithms during normal operation before receiving a sensor failure signal from the one or more sensors.

5. The system of claim 4, wherein adjusting the one or more control algorithms used to control the one or more non-light emitting, variable transmission devices comprises utilizing the prioritization of the one or more control algorithms created during normal operations.

6. The system of claim 1, wherein the processor is further configured to receive an active sensor signal, wherein the active sensor signal indicates the one or more sensors are working.

7. The system of claim 1, wherein the processor is further configured to determine whether a time-out frame is reached.

8. The system of claim 7, wherein the time-out frame is between 24 hours and 48 hours.

9. The system of claim 1, wherein each of the one or more non-light emitting, variable transmission devices comprises:
a substrate;
a first transparent conductive layer;
a second transparent conductive layer;
a cathodic electrochemical layer between the first transparent conductive layer and the second transparent conductive layer; and
an anodic electrochemical layer between the first transparent conductive layer and the second transparent conductive layer.

10. The system of claim 9, wherein each of the one or more electrochromic devices further comprises an ion conducting layer between the cathodic electrochemical layer and the anodic electrochemical layer.

11. The system of claim 10, wherein the ion-conducting layer comprises lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, or any combination thereof.

12. The system of claim 9, wherein the cathodic electrochemical layer comprises WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

13. The system of claim 9, wherein the first transparent conductive layer comprises indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

14. The system of claim 9, wherein the second transparent conductive layer comprises indium oxide, indium tin oxide, doped indium oxide, tin oxide, doped tin oxide, zinc oxide, doped zinc oxide, ruthenium oxide, doped ruthenium oxide and any combination thereof.

15. A method for controlling one or more non-light emitting, variable transmission devices, comprising:
receiving a sensor failure signal from one or more sensors, wherein the sensor failure signal indicates the one or more sensors are not working, and wherein receiving the sensor failure signal is performed by a processor connected to the one or more sensors;
adjusting one or more control algorithms used to control the one or more non-light emitting, variable transmission devices based on the received sensor failure signal; and
sending a first command to the one or more non-light emitting, variable transmission devices to change a transmission state of at least one of the one or more non-light emitting, variable transmission devices based on the adjusted one or more control algorithms.

16. The method for controlling the one or more non-light emitting, variable transmission devices of claim 15, wherein adjusting the one or more control algorithms used to control the one or more non-light emitting, variable transmission devices comprising running the algorithm on calculated data and omitting measured data from the one or more sensors.

17. The method for controlling the one or more non-light emitting, variable transmission devices of claim 15, further comprising receiving data from the one or more sensors after the first command is sent.

18. The method for controlling the one or more non-light emitting, variable transmission devices of claim 17, further comprising adjusting a second time the one or more control algorithms after the data from the one or more sensors is received to run the one or more control algorithms based on both calculated data and measured data from the one or more sensors.

19. The method for controlling the one or more non-light emitting, variable transmission devices of claim 18, sending a second command to the one or more non-light emitting, variable transmission devices to change the transmission state of all of the one or more non-light emitting, variable transmission devices based on the second adjusted one or more control algorithms.

20. A non-transitory computer readable medium containing a program of instructions for controlling one or more non-light-emitting, variable transmission devices, execution of which by a processor causes the steps of:
receiving a sensor failure signal from one or more sensors, wherein the sensor failure signal indicates the one or more sensors are not working, and wherein receiving the sensor failure signal is performed by a processor connected to the one or more sensors;
adjusting one or more control algorithms used to control the one or more non-light emitting, variable transmission devices based on the received sensor failure signal; and
sending a first command to the one or more non-light emitting, variable transmission devices to change a transmission state of all of the one or more non-light emitting, variable transmission devices based on the received sensor failure signal.
